(19) United States
(12) Patent Application Publication
(10) Pub. No.: US 2007/0209274 A1
(43) Pub. Date: Sep. 13, 2007

(54) Plant-Based Production System and Method of Producing Products from Plants

(75) Inventor: James Ladd, Durham, NC (US)

Correspondence Address: IP STRATEGIES, 12 1/2 WALL STREET, SUITE I, ASHEVILLE, NC, 28801, US

(73) Assignee: Matrix Technology Alliance, Inc., Durham, NC (US)

(21) Appl. No.: 11/683,780

(22) Filed: Mar. 8, 2007

Related U.S. Application Data
(60) Provisional application No. 60/780,928, filed on Mar. 8, 2006.

(51) Int. Cl. A01G 9/08

(52) U.S. Cl. 47/1.01 R

(57) ABSTRACT

A plant commercialization system includes a structure that is adapted for growing plants therein, a waste-conversion unit that is adapted to provide energy for the structure, and a production facility that is adapted to produce a product from plants grown in the structure. A plant commercialization method includes providing a structure that is adapted for growing plants therein, converting waste to energy to be used by the structure, growing plants in the structure, and producing a product from the plants grown in the structure.

### CROSS-REFERENCE TO RELATED APPLICATION

This is related to, and claims the benefit under 35 USC §119(e) of U.S. Provisional Application for Patent No. 60/780,928, which was filed on Mar. 8, 2006.

### FIELD OF THE INVENTION

The invention relates to the production of plant-based products.

### BACKGROUND OF THE INVENTION

Plant-based products are in high demand, and are part of a growing market. Many industries, such as the nutrition, cosmetic, and pharmaceutical industries, are based in large part on plant-derived components. Unfortunately, growing the necessary plants, and extracting the necessary components, can be expensive. Further, the extraction process can produce harmful side effects. Although industries based on plant-derived components are thriving, lowering the cost of producing these products and developing new products would boost the market further, and would put the benefits of these industries within the reach of more consumers.

The largest cost in growing the plants is energy. There are several industries that produce waste material that can be used to provide energy, but this potential is underutilized.

It is an objective of the invention to make use of waste produced by various sources, and innovative techniques for extracting plant components, to provide a system of developing and producing products from plants that is economical, safe, and healthy.

### BRIEF SUMMARY OF THE INVENTION

The invention is a plant-growing system and process that provides plant-based products, using energy provided by waste conversion from untapped sources.

According to an aspect of the invention, a plant commercialization system includes a structure that is adapted for growing plants therein, a waste-conversion unit that is adapted to provide energy for the structure, and a production facility that is adapted to create a product from plants grown in the structure. The structure can be, for example, a greenhouse.

The structure preferable is adapted for the organic growing of plants, and the production facility preferably is adapted for organic production of the plant product. For example, the production facility can be adapted to create the plant product using Naturol technology.

The production facility can be adapted to extract oil from the plants, in which case the product can be based on the extracted oil. For example, the product can be an industrial oil. Preferably, the production facility is adapted to extract oil using Naturol technology.

The production facility can be adapted to extract a pharmaceutical component from the plants, in which case the product can be based on the extracted pharmaceutical component.

The product can include a botanical, a nutritional supplement, a fragrance, a cosmetic, an insecticide, a nutriceutical, and/or a food product. The food product can include, for example, a flavoring component and/or a coloring component. As another example, the product can be a nutritional supplement, such as one that includes a protein component. The production facility can be adapted to use tobacco to grow protein for the protein component. The structure can be adapted to grow the tobacco.

The structure can also be adapted to grow seedlings of field plants.

The waste-conversion unit is adapted to produce usable energy and/or a fuel source from waste material. The waste material can include tires, medical waste, and/or waste vegetable oil. The structure is adapted to use the usable energy and/or fuel source, for example, to power a temperature-control system of the structure.

The waste-conversion unit can be adapted to produce carbon dioxide, and the structure can be adapted to deliver the carbon dioxide to the plants.

The structure can be adapted to use waste produced by an aquaculture system as fertilizer for the plants. Alternatively, the plant commercialization system can also include an aquaculture system, and the structure can be adapted to use waste produced by the aquaculture system as fertilizer for the plants.

According to another aspect of the invention, a plant commercialization method includes providing a structure that is adapted for growing plants therein, converting waste to energy to be used by the structure, growing plants in the structure, and producing a product from the plants grown in the structure. The structure can be, for example, a greenhouse.

Preferably, the plants are grown organically, and the product is produced organically. For example, the product can be produced using Naturol technology.

The method can also include extracting oil from the plants. For example, producing a product from the plants can include extracting oil from the plants. For example, the product can be an industrial oil. The oil can be extracted using Naturol technology.

The method can include extracting a pharmaceutical component from the plants, for example, as part of the process of producing the product.

The product can include a botanical, a nutritional supplement, a fragrance, a cosmetic, an insecticide, a nutriceutical, and/or a food product. The food product can include, for example, a flavoring component and/or a coloring component. As another example, the product can be a nutritional supplement that includes a protein component. Tobacco can be used to grow protein for the protein component. The method can include growing the tobacco.

The method can also include growing seedlings of field plants in the structure.

Converting waste to energy can include producing usable energy and/or a fuel source from waste material. The waste material can include tires, medical waste, and/or waste vegetable oil. The method can also include using the usable energy and/or the fuel source to power a temperature-control system of the structure.

Converting waste to energy can include producing carbon dioxide and delivering the carbon dioxide to the plants.

The method can also include using waste produced by an aquaculture system as fertilizer for the plants. The method can also include providing the aquaculture system from which the waste is generated.

### BRIEF DESCRIPTION OF THE DRAWINGS

FIG. 1 is a schematic diagram of an exemplary plant commercialization system according to the invention.

FIG. 2 is a schematic diagram of an exemplary plant commercialization system according to the invention, including input from an aquaculture system.

### DETAILED DESCRIPTION OF THE INVENTION

The invention provides sustainable, environmentally-friendly economic development opportunities through profitable technology centers that play a key role in the creation of sustainable micro-economies.

According to the invention, such a technology center is designed to capitalize on the potential synergy created by the integration of the technologies of different branches of viable alternative energy technologies. These centers in turn can create a viable “micro-economy.”

According to the invention, a technology center can include one or more of the following exemplary components:
1) An alternative energy production component, such as a waste-to-energy unit designed to process “boutique” wastes that usually incur high tipping fees, such as tires, medical wastes, or waste vegetable oil.
2) A state-of-the-art aquaculture system with a waste system that can be integrated synergistically with the production of high-value botanicals and other plant products as a natural provider of fertilizing material.
3) Greenhouses or other structures that can be used to grow high-value plants in a certifiable organic environment.
4) A process for creating valuable products from the plants grown in the greenhouses.

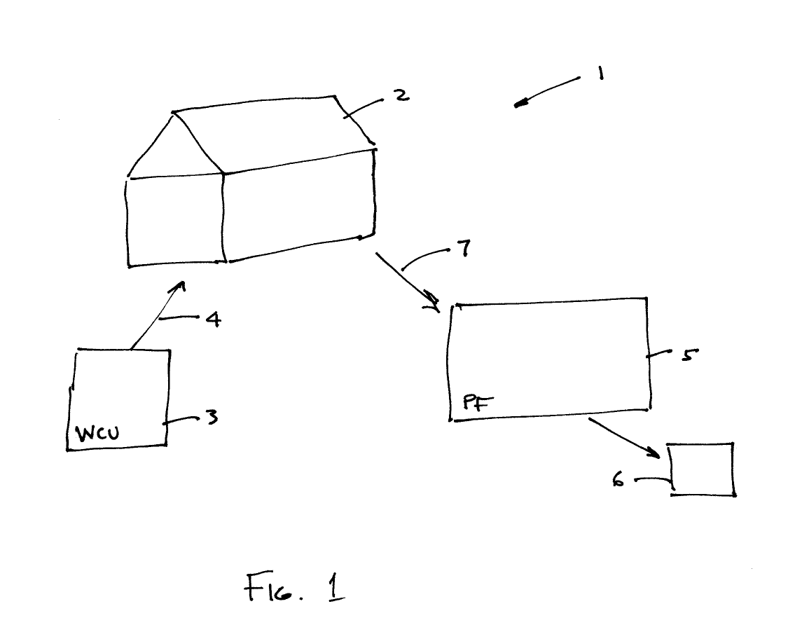

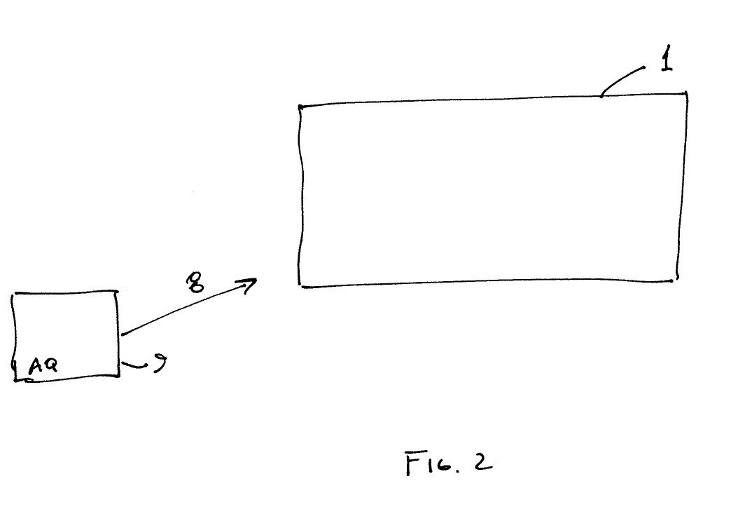

As shown in FIG. 1, a plant commercialization system 1 according to the invention includes a structure 2 that is adapted for growing plants therein, a waste-conversion unit 3 that is adapted to provide energy 4 for the structure 2, and a production facility 5 that is adapted to create a product 6 from plants 7 grown in the structure 2. The structure 2 can be, for example, a greenhouse. The system 1 can also be adapted to use waste 8 produced by an aquaculture system 9 as fertilizer for the plants, as shown in FIG. 2. Alternatively, the plant commercialization system 1 can also include the aquaculture system 9, and the structure 2 can be adapted to use waste 8 produced by the aquaculture system 9 as fertilizer for the plants.

The aquaculture, greenhouse, and value-added components of the technology center can be based on convention technologies, proprietary technologies, or a combination of both. The greenhouse component preferably will use an enhanced primary growing medium, such as AgriCell®, which is described below. AgriCell® will provide an ideal growing medium for almost any plant, although any growth medium having some of the same or similar qualities is suitable for use as a component of the invention. In addition, plants grown in AgriCell® or a similar medium can be certified as “organic,” further enhancing the value of products derived from the plants.

The highest variable cost in operating a commercial greenhouse is energy. In the model of the invention, that energy might not only be “free,” it is potentially the by-product of a waste-to-energy process that has already generated a profit. There are several options for providing such an energy source.

The greenhouses in a technology center according to the invention preferably will grow specialized plants (or seedlings for transplant) based on their value as sources of, for example, premium oils, many medicinal in nature. The model of the invention easily lends itself to the production of more traditional greenhouse plants as well. The cost and quality of the plants produced in such a center would be quite competitive with those grown according to conventional methods. Greenhouses according to the invention are described in more detail below.

The greenhouses will provide the raw materials for the production component of the system. This production is based on the extraction of the oils or other components from the plants grown in the greenhouses. This extraction preferably is achieved by application of an organic, state-of-the-art technology for botanical oil extraction, such as Naturol technology, which is owned by Integrated Environmental Technologies, Inc., as described below.

The model of the invention can be a vehicle for economic development. It was specifically designed to produce sustainable employment opportunities. Individuals who traditionally have been employed in industries that have been downsized or outsourced to workers in foreign countries, such as tobacco, textiles, and others, can fill most of the jobs in a technology center set up according to the invention. The market for such oils and other plant-based products is in the billions of dollars and rapidly growing. Because of the synergy created within the components of a technology center set up according to the invention, such a center has built-in competitive advantages for producing even the most valuable of these products. From a practical standpoint, hundreds of centers can be developed to utilize various waste streams and supply valuable oils and other products. This could result in the salvation and/or creation of thousands of jobs, depending on the size of the greenhouses, and help eliminate the use of hazardous waste dumping.

Another factor contributing to the viability of a technology center according to the invention as an economic development tool is its location flexibility. Such a technology center can be placed almost anywhere, particularly in locations that have easy access to markets for fresh fish, organic vegetables and spices, and botanicals. Thus, there are numerous locations, especially in economically depressed areas, where such a center could be advantageously constructed. As a result, jobs can be created where they are needed the most.

The potential for creating sustainable jobs where the need for those jobs exists will contribute to the success in facilitating the proliferation of the inventive technology center.

Ideal attributes for a growth medium used in greenhouses as an element of the present invention are now described. Other growth media exhibiting different qualities and attributes are also contemplated for use, although preferred media will provide attributes similar to at least some of those listed. Such a growth medium should be a soil substitute, be a growth enhancer overall, produce an increase in initial plant development when compared to other growing media, reduce need of watering, hold water, nutrients, and additives at root level, thus helping to mitigate pollution of water ways and aquifers, reduce onslaught of drought stress for long periods, increase germination rates, increase plant yield, reduce need of addition of nitrogen and phosphorus, provide aeration, be fully biodegradable, promote root growth and formation, decrease plant transplant shock (allow the root ball to become cohesive unit, enabling removal of plant from starter containers to soil), virtually eliminate plant death caused by transport (normal greenhouse transport of seedlings to garden centers results in loss of 1% of plants per 5 miles of shipping), reduce need for tilling, be pathogen and insect free, increase consistency of nutrient and water availability, reduce dependency on potentially hazardous materials such as perlite, vermiculite, and rock wool, and be able to substitute for peat (a diminishing resource which, when harvested, releases absorbed contaminants).

As discovered or confirmed by empirical evidence garnered by Virginia Polytechnic Institute and State University (VA Tech), Department of Crop and Soil Environmental Sciences at Blacksburg, Va., or by North Carolina State University, Horticultural Substrates Laboratory, AgriCell® Foam exhibits all of these attributes, and therefore would be ideal for use as a component of the present invention. Other growth media, however, can be used advantageously, particularly if the growth medium exhibits many of the qualities noted above.

The potential profitability of the Greenhouses will be greatly enhanced by the use of AgriCell®, a proprietary soil replacement and soil enhancer manufactured by EnviroTek International Corporation, as a key “ingredient” in the plant growing media. AgriCell® is an environmentally friendly product containing 60% open cells, which hold water and suspended elements such as fertilizer, and 40% closed cells, which make available necessary gases for plant growth. As AgriCell® slowly biodegrades, it becomes a source of nutrients for plants. The unique open cell structure can result in as much as a two-thirds reduction in the watering requirement for plants, as well as a dramatic reduction in potential polluting run-offs. AgriCell® is also insect- and pathogen-free, thereby enhancing its benefits as a soil replacement and soil enhancer.

AgriCell® satisfies the criteria mentioned above by significantly reducing watering requirements by as much as two-thirds by increasing water availability to plants 50-100% and delaying drought stress two to four times longer. It also jump-starts and delivers superior growth performance by improving plant appearance and marketability by 60-80%, speeding early plant development by 20-30%, increasing germination rate by 20-50%, and yielding greater plant growth, without additional fertilizers, by 25-85%. AgriCell® promotes critical aeration and root development, and minimizes tilling requirements, provides a pathogen- and insect-free medium and quickens pH balancing efforts, enables plant shipments with less loss, enables better and healthier transplanting with less loss due to plant stress, and does so at a cost comparable to and technique superior to competing non-environmentally conscious products.

Many companies and government research agencies have attempted to scientifically engineer more environmentally-friendly agricultural products. But these products have typically failed due to poor performance and higher price. Like any industry, change only can be achieved if there is sufficient financial incentive (that is, cost savings or performance gains) to change customer-buying behavior. AgriCell® products are designed with this in mind. The products are engineered to produce superior product-performance benefits and cost reductions while delivering significant environmental and plant benefits. This preferred product line has been engineered to be capable of driving environmentally-conscious agriculture into the mainstream in an economically viable manner.

AgriCell®-based products are designed to provide cost, performance, and environmental benefits to various segments of the agricultural and horticultural industry. Plant growers, whether retail, wholesale, commercial or government, will reduce labor costs associated with watering and fertilizing as well as material costs related to runoff and plant loss. AgriCell® amended potting mixes are more efficient in retaining water. The unique properties of AgriCell® reduce the loss of irrigation water and important plant nutrients and thereby allow growers to reduce significantly scheduled waterings and affiliated operating inefficiencies. Moreover, this retention lessens the likelihood of polluting run-offs. AgriCell® also enhances plant growth rates, assuring growers a quicker turn-around time, enhances plant root growth, thus enabling less loss as consumers transplant, and enables growers to ship plants with less loss due to plant stress.

Use of AgriCell® permits the introduction of various additives; many growers use different soil compositions for various crops they plant. AgriCell® can customize soil-mixes to support different growing needs within a greenhouse or a technology center of the invention. AgriCell® is designed so that additives, such as fertilizers and other growth nutrients, can be introduced during the manufacturing process. Therefore, uniquely customizable products can be provided that accommodate the specific needs for individual customers and specific segments of the agriculture and horticulture industries.

The loss of nutrients by leaching is costly (conventional fertilizing techniques typically leach 50% of nutrients) and has a severe impact on watersheds. AgriCell® is engineered to provide a more effective nutrient and plant-friendly base, which jump-starts growth. Its open cell structure more effectively holds water and nutrients at root level and reduces leaching into local groundwater tables than other available products.

AgriCell® is engineered as a foam that fully biodegrades into nitrogen and phosphorous, essential nutrients required to promote agricultural growth. The foam provides consistent nutrient availability over longer periods of time than any existing product.

AgriCell® foams are insect- and pathogen-free when produced and offer less exposure to dangerous pathogens, thus reducing sterilization efforts currently required with the use of many commercially available soil compounds. AgriCell® reduces significantly the costs for commercial growing operations and the manufacture of soil-less potting media.

The commercial greenhouse component of the technology center can be synergistic with one or more of the other components. The potential synergy with each of the other components can be significant. For example, the waste-to-energy component can provide energy for both heating and cooling, helping to regulate the temperature in the greenhouse, an important factor for plant growth and nurturing. Energy is typically the highest variable cost in operating a commercial greenhouse. The waste-to-energy component can also be a source of carbon dioxide, which can accelerate the healthy development of the plants grown in the greenhouse. The product development component can be a market for specialized botanicals and other plant-based products that require a controlled growing environment. The commercial greenhouses can provide such a growing environment. Capitalizing on one or more of these synergies can greatly enhance the overall profitability of the center.

The commercial greenhouse component has significant inherent flexibilities, depending on factors such as the degree of integration desired with the product development component. The following is a description of the major greenhouse options that can be incorporated in a center.

Conventional greenhouse operations produce typical greenhouse fruits and vegetables such as tomatoes, lettuce and so on. Their major emphasis, however, is on the production of non-conventional agricultural crops such as chives and oriental herbs and spices. The ability to produce these crops organically on a year-round basis will provide significant competitive advantages in the marketplace.

Specialty greenhouses are pathogen- and insect-free greenhouses that specialize in non-traditional (but lucrative) greenhouse plants, including plants producing oils for medicinal, nutritional, food, cosmetic, and commercial chemical markets. These plants can be produced on a contract basis for the product development component.

The product development component will require from time to time more of a certain plant than can be grown in a greenhouse. Such plants will be grown in traditional, open field settings. The seedlings required for growing in this manner will be developed in nurseries or greenhouses in the most cost effective center available.

One option created by the greenhouses is the potential development of agribusinesses concentrating on state-of-the-art plant-based biotechnology applications. For example, one initiative in the biotechnology community involves the use of tobacco to grow various proteins. These proteins have application in the nutritional, medical, and commercial chemical fields. The ability to use tobacco for this purpose can create myriad opportunities for extended economic development. In order to be viable commercially, these potential agribusinesses must have access to agri-based production centers capable of producing tobacco cost-effectively in tremendous volumes in controlled environments. The commercial greenhouses in the technology center of the invention can satisfy all these requirements.

A technology center of the invention can be designed to include one or more of the options described above. The greenhouses also can be adapted to be used in applications other the initial one(s) in response to new market opportunities.

One application of the technology center of the invention is the development and production of a plant-based product. For example, certain plants can be grown for the purpose of extracting valuable oils from the plants. These oils can be used as the basis of other commercial products, or the oils themselves can be the end product produced by the center. The following is a discussion of techniques that can be used to extract the oils from the plants.

Super-critical carbon dioxide extraction is the technology that is used to make decaffeinated coffee, as well as hop extracts for the brewing industry. This type of extraction is contemplated for use with the invention. While the quality of the products produced by this technology is generally very high, this quality is achieved at a very significant capital and operating cost. Super-critical carbon dioxide extraction systems operate at extremely high pressures, about 5000 to 7500 psi. These elevated pressures are rarely used anywhere in industry and therefore require costly custom-designed equipment.

Steam Distillation is the principal method used in developing countries for the extraction of plant oils and compounds. This method has been used for over one thousand years. Steam distillation requires the heating of large volumes of water to create steam for processing the plant material so that the extract can be removed by distillation. This method is very energy intensive and frequently poses a significant waste disposal problem. In addition, the products yielded by this process have all been “cooked” at temperatures at or in excess of 100 degrees C. This heating results in significant chemical changes within the end products. The extracts are recovered by vaporizing the extract or dissolving it in boiling water or steam. The primary utility of steam distillation is the recovery of water-soluble compounds or lower molecular weight materials, which readily vaporize.

Because of the problems and deficiencies associated with steam distillation, the extraction method chosen by the industrialized world for the past century has utilized alcohols (to form tinctures) or hydrocarbon solvents. The most popular and widely used solvent is hexane. Hexane solvent extract, because of hexane's highly flammable nature, is extremely hazardous, as demonstrated during the past decade by a number of explosions that have occurred at manufacturing facilities using hexane.

Vapors commonly emitted during an extraction process using hexane are “VOCs,” or volatile organic compounds. VOCs can lead to respiratory problems such as asthma and bronchitis. The United States Environmental Protection Agency has recently promulgated strict limits on VOC emissions (particularly hexane emissions) into the atmosphere and has mandated strict control and reporting requirements when hexane is used. Canada and Europe are considering similar restrictions.

The hexane solvent residue levels in plant extracts left by this extraction process are becoming unacceptable to many legislators and regulators in the food industry. This is likewise the case with many consumers, who are becoming acutely aware of the toxic nature of these residuals. Further restrictive legislation and regulations on these residues are pending. The products of hexane extraction usually require further costly refinement with alcohol, and hexane itself is widely considered to be carcinogenic. As is the case with steam distillation, all hexane-derived products are exposed to high temperatures for long periods in attempts to reduce residual hexane levels, thereby degrading the quality and efficacy of the final products.

The Naturol extraction process almost entirely eliminates damage to bioactive compounds during the extraction and recovery process. As a result, far better, purer, cleaner, and more active pharmaceuticals and nutraceuticals can be produced. This, in combination with the elimination of toxic residual solvents in the final products and the benign effect of the process on the environment, places Naturol technologies in a very strong position to become the leading technology in these highly lucrative business sectors.

The Naturol extraction technologies are a major breakthrough in the effective, low-cost extraction of high-value bioactive compounds and oils from plants and other sources. These innovative extraction technologies were developed by Peter F. Wilde, Ph.D. based on his discovery of a unique new family of eco-friendly liquid solvents (see U.S. Pat. No. 6,860,998 and No. 6,890,424. Extracting bioactive compounds is a rapidly growing global business, which generates billions of dollars annually. The applications developed using the Naturol extraction technologies are superior in almost every respect to both steam distillation and solvent extraction, the world's principal methods for producing such extracts. Solvent extraction, the current method of choice, is under increasing attack due to its reliance on solvents that are known to be either toxic, carcinogenic, or flammable. The Naturol Technologies have none of these harmful and dangerous attributes. Further, a Naturol extraction system operates at a pressure that is close to that of a bottle of champagne. Consequently, the cost of a super-critical carbon dioxide extraction system is ten to twenty times the cost of a comparable Naturol system.

The superiority of the Naturol Extraction Technology creates myriad business opportunities in a number of lucrative industries, including pharmaceutical, food, fragrance, bio-insecticide, industrial oils, and nutraceutical. Each of these industries is rapidly expanding its use of plant-based extracts, and the Naturol technologies are positioned to become a major force in the production of these extracts.

Plant extraction technology in North America, Europe, and other industrialized regions has remained almost unchanged for the last hundred years. As indicated earlier, solvent extraction is currently the preferred method. In solvent extraction, the biomass from which the desired product is to be extracted is mixed with a liquid (solvent). The solvents are typically alcohols (methanol, ethanol isopropanol), dichloromethane, hexane (similar to gasoline), and super-critical carbon dioxide. With the exception of super-critical carbon dioxide, most of these solvents are known to be toxic, carcinogenic (they are linked to cancer in animals and humans), and flammable. These solvents also deplete the ozone layer and produce what are considered to be “greenhouse gases.” Given that these solvents leave measurable residues in the oils and bio-compounds they extract, they are highly undesirable additives for any product consumed or used by humans.

Problematically, residues (particularly hexane) remain in extracts used by the food, pharmaceutical, and fragrance industries. A major need exists for a superior extraction system that eliminates not only the problems associated with these solvents, but at the same time produces a superior, safer product at significantly lower production costs. Naturol technologies can supply such an alternative.

The Naturol technologies use a new group of eco-friendly solvents. The key advantages of these solvents over the primary competitive extraction systems include significantly lower production costs, higher product yields, higher quality, and totally safety; the solvents are non-flammable and inert. The extracts are achieved at ambient temperatures or below. Unlike almost all other plant extraction systems, the plants and the dissolved compounds are never subjected to heat, which destroys valuable extracts and degrades the quality of the remaining biomass. All Naturol processing equipment can be assembled as modules and can be moved to the location where the feedstock crops are growing, thereby limiting the possible degradation of the material to be extracted due to time delays incurred by moving the feedstock plants to another site for processing. The solvents in the system are continuously recycled and solvent losses in any production year are unlikely to exceed three percent. Solvent residues in products produced using the Naturol technologies are at least 1000 times less than those in which hexane (widely used and a known carcinogen) is used as the solvent. All of these advantages create tremendous opportunities for Naturol technologies in these huge and rapidly expanding markets.

According to the United Kingdom Department of Agriculture, the global market for plant extract products is estimated to be in excess of $10 billion dollars per year. The following is an overview of some of the specific industry sectors that would benefit from Naturol technologies and the development of technology centers according to the invention.

The past ten years has witnessed a strong and growing interest among pharmaceutical companies in the potential of plants to yield new drugs and medicines. About 20% of all drugs and medicines used in North America and Europe today are directly derived from plants. Access to the bioactive compounds in plants requires the best available extraction processes. Many of the plant extractions needed in this highly profitable business sector can be extracted by the inventive technology center. These extractions include artemicimin (from Artemsia annua leaves), a new front line drug for treating malaria; colchicines (from Colchcum autumnale roots), a powerful anti-inflammatory; coumarin (from tonka beans), a widely used blood anti-coagulant; kavalactones (from Piper methysticum, also known as St. John's wort), a natural anti-depressant; taxanes (Paclitaxel from the Canadian yew tree), a powerful a anti-cancer drug; saw palmetto, a prostate cancer treatment; lutein, treatment for macular degeneration; policossanol and tocotrienols, treatments for cardiovascular disease and high blood pressure; astaxanthin, a powerful antioxidant; and squalene and squalamine, chemotherapy agents.

Further, the system and method of the invention provide a tremendous opportunity to capture a significant part of the food flavors, fragrance, and color markets.

The term “nutraceuticals,” also referred to as “functional foods,” is applied to a group of plant extracts that are widely accepted as bringing both health and nutrition benefits to the consumer. Typical nutraceuticals are ginseng, kava, and gingko biloba. These compounds are being incorporated into a wide variety of common foods. Lutein is already appearing in value-added food products.

The nutraceutical business is now global in scope, and generates annual sales in excess of $100 billion. Importantly, sales are growing at an annual rate of 7-8%. This creates an incredible opportunity for the inventive system.

An area related to nutraceuticals is the booming “cosmeceuticals” market, estimated by Freedonia Market Research Group to be the $4.1 billion by 2003. Skincare products alone in this sector are estimated to be $2.3 billion by that year. Key to the successful entry into this market is the ability to produce in an eco-friendly way plant extracts of the highest purity, with no (or minimal) health hazards.

With the rising concern over the use of chemical insecticides on food crops, there is an increase in worldwide research to identify natural insecticides, most of which come from plants. The inventive technology centers are well suited to perform the extractions necessary to produce a wide-variety of bio-insecticide products. For example, the ability to extract pyrethroids from the pyrethrum plant has been demonstrated. Pyrethrum has historically been the most widely-used naturally derived insecticide, but in recent years has been supplanted in many cases by chemical-based insecticides. Due to environmental concerns and restrictive environmental regulations, this trend appears to be reversing and pyrethrum is enjoying a resurgence in popularity.

A by-product of the extraction of lutein from marigold plants is the isolation of compounds that are known to insecticides and may be toxic to nematodes. The system of the invention can be a valuable tool in making it possible to produce such bio-insecticides at commercially viable prices.

A great deal of research is currently being conducted to identify plant oils that are useful for industrial purposes and which are as effective as, and economical as, hydrocarbon-based oils, but which are environmentally more benign. For example, linseed oil, a high quality industrial lubricant in use for many years, is extracted from flax. Canola, rapeseed, and soy oils are beginning to find industrial applications. Soy meal is used in producing adhesives and composites; soy oil is used in plastics and inks, and as solvents and lubricants. It is estimated that soy-based lubricants may capture 15% of the lubricants market, in part because they are biodegradable.

A plant oil with which Naturol has been tested is Veronia. Veronia is unique in that it contains a natural epoxy that can potentially replace hydrocarbon epoxies in a number of industrial applications. One such application is in oil-based paints. It is estimated by the USDA that the VOCs given off by oil-based paints account for about 5% of the air pollution in Los Angeles. The potential long-term market of Veronia is estimated to be in the hundreds of millions of dollars, and the system of the invention has the potential to solve the problem of how to make it available in commercial quantities.

Another application of the system of the invention involves the recovery of proteins from seeds. The following is a description of how the Naturol solvent extraction process has demonstrated its potential in enhancing the recovery of protein from canola seeds.

The properties of canola meal obtained by processing canola seeds using one of Naturol's applications are summarized below. The Naturol process is compared to extraction using hexane, the most commonly used solvent. Extraction using hexane is the industry standard. The Naturol process is less expensive and does not require the high temperature used in the hexane process. The high temperature required by the hexane extraction process reduces the quality and nutrient value of both the oil and meal derived using the hexane approach.

| | Hexane Extracted | Naturol Extracted |
|---|---|---|
| Protein Content (%) | 34-37 | 41 |
| Protein solubility in | 15 | 29 |
| NaCl Solution, mg/ml | | |
| (in a 15% w/y mix of | | |
| meal with salt- | | |
| water solution) | | |
| Residuals | 2-4% oil | <1% oil |
| | 8-12% fats | <1% fat |
| | 1-? % residual solvent | <1 ppm residual solvent |

Of key importance is the finding that total protein content of the Naturol-extracted meal is 41%, compared to the hexane standard of 34-37%. The soluble protein (a portion of the total protein) is 29%, compared to the Hexane standard of 15%.

These results—which were obtained in the first attempt to apply the Naturol solvent extraction process on canola—have significant commercial implications. Extracted canola meal is sold as animal feed for about $100/ton. The Saskatchewan Canola Development Commission reports that for every 2% increase in protein content (over the base of 34%) of the extracted canola meal, the value increases by at least $16/ton. Thus, the value of the canola meal derived from the Naturol process is potentially increased by about $56/ton.

The system of the invention provides an effective and economical method for recovering soluble (food grade) protein from the entire range of protein-bearing seeds, including soybean, sunflower, cottonwood, flax, and so on. The current market price for food grade protein (used extensively as a thickening agent by the world's food processing industries) is in the $7,000/ton range. Use of processes that avoid the pitfalls of conventional processes, such as by use of Naturol extraction technology, will better position the system of the invention to tap into these markets and develop a significant number of new, dynamic, sustainable businesses.

We claim:

1. A plant commercialization system, comprising:
a structure that is adapted for growing plants therein;
a waste-conversion unit that is adapted to provide energy for the structure; and
a production facility that is adapted to produce a product from plants grown in the structure.

2. The plant commercialization system of claim 1, wherein the structure is a greenhouse.

3. The plant commercialization system of claim 1, wherein the structure is adapted for the organic growing of plants, and the production facility is adapted for organic production of the plant product.

4. The plant commercialization system of claim 3, wherein the production facility is adapted to create the plant product using Naturol technology.

5. The plant commercialization system of claim 1, wherein the production facility is adapted to extract oil from the plants.

6. The plant commercialization system of claim 5, wherein the product is based on the extracted oil.

7. The plant commercialization system of claim 6, wherein the product is an industrial oil.

8. The plant commercialization system of claim 5, wherein the production facility is adapted to extract oil using Naturol technology.

9. The plant commercialization system of claim 1, wherein the production facility is adapted to extract a pharmaceutical component from the plants.

10. The plant commercialization system of claim 9, wherein the product is based on the extracted pharmaceutical component.

11. The plant commercialization system of claim 1, wherein the product includes at least one of a botanical, a nutritional supplement, a fragrance, a cosmetic, an insecticide, a nutriceutical, and a food product.

12. The plant commercialization system of claim 11, wherein the food product includes at least one of a flavoring component and a coloring component.

13. The plant commercialization system of claim 11, wherein the product is a nutritional supplement, and the nutritional supplement includes a protein component.

14. The plant commercialization system of claim 13, wherein the production facility is adapted to use tobacco to grow protein for the protein component.

15. The plant commercialization system of claim 14, wherein the structure is adapted to grow the tobacco.

16. The plant commercialization system of claim 1, wherein the structure is also adapted to grow seedlings of field plants.

17. The plant commercialization system of claim 1, wherein the waste-conversion unit is adapted to produce at least one of usable energy and a fuel source from waste material.

18. The plant commercialization system of claim 17, wherein the waste material includes at least one of tires, medical waste, and waste vegetable oil.

19. The plant commercialization system of claim 17, wherein the structure is adapted to use the at least one of usable energy and a fuel source to power a temperature-control system of the structure.

20. The plant commercialization system of claim 1, wherein the waste-conversion unit is adapted to produce carbon dioxide, and the structure is adapted to deliver the carbon dioxide to the plants.

21. The plant commercialization system of claim 1, wherein the structure is adapted to use waste produced by an aquaculture system as fertilizer for the plants.

22. The plant commercialization system of claim 1, further comprising an aquaculture system.

23. The plant commercialization system of claim 22, wherein the structure is adapted to use waste produced by the aquaculture system as fertilizer for the plants.

24. A plant commercialization method, comprising:
providing a structure that is adapted for growing plants therein;
converting waste to energy to be used by the structure;
growing plants in the structure; and
producing a product from the plants grown in the structure.

25. The plant commercialization method of claim 24, wherein the structure is a greenhouse.

26. The plant commercialization method of claim 24, wherein the plants are grown organically, and the product is produced organically.

27. The plant commercialization method of claim 26, wherein the product is produced using Naturol technology.

28. The plant commercialization method of claim 24, further comprising extracting oil from the plants.

29. The plant commercialization method of claim 28, wherein producing a product from the plants includes extracting oil from the plants.

30. The plant commercialization method of claim 29, wherein the product is an industrial oil.

31. The plant commercialization method of claim 28, wherein the oil is extracted using Naturol technology.

32. The plant commercialization method of claim 24, further comprising extracting a pharmaceutical component from the plants.

33. The plant commercialization method of claim 32, wherein producing a product from the plants includes extracting the pharmaceutical component from the plants.

34. The plant commercialization method of claim 24, wherein the product includes at least one of a botanical, a nutritional supplement, a fragrance, a cosmetic, an insecticide, a nutriceutical, and a food product.

35. The plant commercialization method of claim 34, wherein the food product includes at least one of a flavoring component and a coloring component.

36. The plant commercialization method of claim 34, wherein the product is a nutritional supplement, and the nutritional supplement includes a protein component.

37. The plant commercialization method of claim 36, further comprising using tobacco to grow protein for the protein component.

38. The plant commercialization method of claim 37, further comprising growing the tobacco.

39. The plant commercialization method of claim 24, further comprising growing seedlings of field plants in the structure.

40. The plant commercialization method of claim 24, wherein converting waste to energy includes producing at least one of usable energy and a fuel source from waste material.

41. The plant commercialization method of claim 40, wherein the waste material includes at least one of tires, medical waste, and waste vegetable oil.

42. The plant commercialization method of claim 40, further comprising using the at least one of the usable energy and the fuel source to power a temperature-control system of the structure.

43. The plant commercialization method of claim 24, wherein converting waste to energy includes producing carbon dioxide and delivering the carbon dioxide to the plants.

44. The plant commercialization method of claim 24, further comprising using waste produced by an aquaculture system as fertilizer for the plants.

45. The plant commercialization method of claim 24, further comprising providing an aquaculture system.

46. The plant commercialization method of claim 45, further comprising using waste produced by an aquaculture system as fertilizer for the plants.
